(19) United States
(12) Patent Application Publication
(10) Pub. No.: US 2007/0062251 A1
(43) Pub. Date: Mar. 22, 2007

(54) Infusion Pump With Closed Loop Control and Algorithm

(75) Inventor: Deon Anex, Livermore, CA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: LifeScan, Inc., Milpitas, CA (US)

(21) Appl. No.: 11/532,598

(22) Filed: Sep. 18, 2006

Related U.S. Application Data
(60) Provisional application No. 60/718,572, filed on Sep. 19, 2005.
(60) Provisional application No. 60/718,397, filed on Sep. 19, 2005.
(60) Provisional application No. 60/718,412, filed on Sep. 19, 2005.
(60) Provisional application No. 60/718,577, filed on Sep. 19, 2005.
(60) Provisional application No. 60/718,578, filed on Sep. 19, 2005.
(60) Provisional application No. 60/718,364, filed on Sep. 19, 2005.
(60) Provisional application No. 60/718,399, filed on Sep. 19, 2005.
(60) Provisional application No. 60/718,400, filed on Sep. 19, 2005.
(60) Provisional application No. 60/718,398, filed on Sep. 19, 2005.
(60) Provisional application No. 60/718,289, filed on Sep. 19, 2005.

(51) Int. Cl. G01F 25/00

(52) U.S. Cl. 73/1.36

(57) ABSTRACT

Systems and methods of controlling the flow of fluid from infusion pumps, such as pumps utilizing an electrokinetic engine, are discussed. In particular, a closed loop control technique can be utilized to regulate movement of a non-mechanically-driven moveable partition, which can be used to drive the flow of an infusion fluid. For example, one or more fluid shot amounts can be delivered by the infusion pump. One or more measured amounts can be determined for the fluid shot amount(s). An average measured amount can be calculated from the measured amounts, and a correction factor can be calculated using the average measured amount and an expected shot amount. Subsequently, a fluid shot amount can be delivered base upon the correction factor. Variations of this method, and systems for implementing the method, or portions thereof, are also discussed.

### CROSS REFERENCE TO RELATED APPLICATIONS

The present application claims the benefit of the following U.S. Provisional Applications, all filed on Sep. 19, 2005: Ser. No. 60/718,572, bearing attorney docket number LFS-5093USPSP and entitled “Electrokinetic Infusion Pump with Detachable Controller and Method of Use”; Ser. No. 60/718,397, bearing attorney docket number LFS-5094USPSP and entitled “A Method of Detecting Occlusions in an Electrokinetic Pump Using a Position Sensor”; Ser. No. 60/718,412, bearing attorney docket number LFS-5095USPSP and entitled “A Magnetic Sensor Capable of Measuring a Position at an Increased Resolution”; Ser. No. 60/718,577, bearing attorney docket number LFS-5096USPSP and entitled “A Drug Delivery Device Using a Magnetic Position Sensor for Controlling a Dispense Rate or Volume”; Ser. No. 60/718,578, bearing attorney docket number LFS-5097USPSP and entitled “Syringe-Type Electrokinetic Infusion Pump and Method of Use”; Ser. No. 60/718,364, bearing attorney docket number LFS-5098USPSP and entitled “Syringe-Type Electrokinetic Infusion Pump for Delivery of Therapeutic Agents”; Ser. No. 60/718,399, bearing attorney docket number LFS-5099USPSP and entitled “Electrokinetic Syringe Pump with Manual Prime Capability and Method of Use”; Ser. No. 60/718,400, bearing attorney docket number LFS-5100USPSP and entitled “Electrokinetic Pump Integrated within a Plunger of a Syringe Assembly”; Ser. No. 60/718,398, bearing attorney docket number LFS-5101USPSP and entitled “Reduced Size Electrokinetic Pump Using an Indirect Pumping Mechanism with Hydraulic Assembly”; and Ser. No. 60/718,289, bearing attorney docket number LFS-5102USPSP and entitled “Manual Prime Capability of an Electrokinetic Syringe Pump and Method of Use.” The present application is also related to the following applications, all filed concurrently herewith: “Electrokinetic Infusion Pump System” (Attorney Docket No.106731-5); “Malfunction Detection via Pressure Pulsation” (Attorney Docket No. 106731-6); “Infusion Pumps with a Position Sensor” (Attorney Docket No. 106731 -18); “Systems and Methods for Detecting a Partition Position in an Infusion Pump” (Attorney Docket No. 106731-21); and “Malfunction Detection with Derivative Calculation” (Attorney Docket No. 106731-22). All of the aforementioned applications in this paragraph are hereby incorporated by reference herein in their entirety.

### FIELD OF THE INVENTION

The present invention relates, in general, to medical devices and systems and, in particular, to infusion pumps, infusion pump systems and associated methods.

### BACKGROUND OF THE INVENTION

Electrokinetic pumps provide for liquid displacement by applying an electric potential across a porous dielectric media that is filled with an ion-containing electrokinetic solution. Properties of the porous dielectric media and ion-containing solution (e.g., permittivity of the ion-containing solution and zeta potential of the solid-liquid interface between the porous dielectric media and the ion-containing solution) are predetermined such that an electrical double-layer is formed at the solid-liquid interface. Thereafter, ions of the electrokinetic solution within the electrical double-layer migrate in response to the electric potential, transporting the bulk electrokinetic solution with them via viscous interaction. The resulting electrokinetic flow (also known as electroosmotic flow) of the bulk electrokinetic solution is employed to displace (i.e., “pump”) a liquid. Further details regarding electrokinetic pumps, including materials, designs, and methods of manufacturing are included in U.S. patent application Ser. No. 10/322,083 filed on Dec. 17, 2002, which is hereby incorporated in full by reference.

### SUMMARY OF THE INVENTION

One exemplary embodiment is directed to a method of controlling fluid delivery from an infusion pump such as an electrokinetic infusion pump or an infusion pump moving fluid with a non-mechanically-driven moveable partition (e.g., hydraulic actuation). The method includes the step of delivering one or more fluid shot amounts from the infusion pump, which can be, for example, discrete fluid shot amounts , or a continuous fluid shot. At least one measured amount can be determined for the fluid shot amount(s), and can be used to calculate an average measured amount. In one instance, determining one or more measured amounts can include determining a measured amount for each of a multiple number of fluid shot amounts. To determine the measured amount, a position of the moveable partition can be determined. A correction factor can be calculated using the average measured amount and an expected amount. Subsequently, fluid can be delivered based at least in part on the correction factor. For instance, pump operation can be adjusted based upon the correction factor (e.g., altering the duration of a subsequent shot, or the voltage and/or current applied between electrodes of an electrokinetic infusion pump).

For the previous exemplary embodiment, one or more weighting factors can be used to weight one or more of the measured amounts to calculate the average measured amount. Such weighting factors can also be chosen to more heavily weight at least one later measured amount relative to at least one earlier measured amount. An average measured amount can also be calculated using a previously calculated average measured amount. For example, the average measured amount can be calculated according to the following relationship:

$${average}_{n} = \frac{( ɛ \times {amt}_{last , meas} ) + {average}_{n - 1}}{ɛ + 1}$$

where n is a number equal to a selected number of measured amounts; averageₙ is the average measured amount calculated using the last n measured amounts; ε is a designated weighting factor; amt_{last,meas} is the last measured amount; and averageₙ₋₁ is the previous average measured amount calculated using all n measured amounts except for the last measured amount.

Calculating a correction factor for the previous exemplary embodiment can also include relating the correction factor to a difference between an average measured amount and an expected amount. In one instance, the difference between the average amount and the expected amount can be multiplied by a proportionality factor to obtain the correction factor.

Another exemplary embodiment is directed to a system for controlling fluid flow from an infusion pump, such as an electrokinetic infusion pump or an infusion pump moving liquid with a non-mechanically-driven moveable partition. The system can include a position detector coupled to the movable partition and can be configured to emit a signal that identifies a position of the movable partition. Possible position detector types include one or more magnetic or optical sensors. When a magnetic sensor is utilized, a magnet can be coupled to the moveable partition. The system also includes a controller coupled to the position detector and the movable partition. The controller can be configured to control delivery of a fluid shot amount from the infusion pump based at least in part upon an expected amount and an average measured amount calculated from multiple previously measured amounts. For example, the controller can be configured to control delivery of infusion fluid based in part on at least a designated fraction of a difference between the average measured amount and the expected amount. In addition, the controller can be configured to alter at least one of voltage applied between electrodes of an electrokinetic infusion pump, current flow between electrodes of the electrokinetic infusion pump, and a shot duration associated with a fluid shot amount from the infusion pump. The previously measured amounts can be based at least in part upon a corresponding signal received from the position detector. In general, the controller can be configured to calculate average measured amounts in accord with the techniques discussed herein. The controller can also be coupled to a power source such that the controller controls delivery of a shot fluid amount by adjusting the power delivered by the power source.

### BRIEF DESCRIPTION OF THE DRAWINGS

FIG. 1A is a schematic illustration of an electrokinetic pump in a first dispense position consistent with an embodiment of the invention, the pump including an electrokinetic engine, an infusion module, and a closed loop controller.

FIG. 1B is a schematic illustration of an electrokinetic pump of FIG. 1A in a second dispense position.

FIG. 2 is flow sheet illustrating a closed loop control algorithm for use with an electrokinetic infusion pump, according to an embodiment of the present invention.

FIG. 3 is an illustration of an electrokinetic infusion pump with closed loop control according to an additional embodiment of the present invention.

FIG. 4 is an illustration of a magnetic linear position detector as can be used in an electrokinetic infusion pump with closed loop control according to an embodiment of the present invention.

FIGS. 5A and 5B illustrate portions of an electrokinetic infusion pump with closed loop control according to an embodiment of the present invention, including an electrokinetic engine, an infusion module, a magnetostrictive waveguide, and a position sensor control circuit. The electrokinetic infusion pump with closed loop control illustrated in FIG. 5A is in a first dispense position, while the electrokinetic infusion pump illustrated in FIG. 5B is in a second dispense position.

FIG. 6 is a block diagram of a circuit that can be used in an electrokinetic infusion pump with closed loop control according to an additional embodiment of the present invention. The block diagram illustrated in FIG. 6 includes a master control unit with master control software that controls various elements including a display, input keys, non-volatile memory, a system clock, a user alarm, a radio frequency communication circuit, a position sensor control circuit, an electrokinetic engine control circuit, and a system monitor circuit. A battery powers the master control unit, and is controlled by a power supply and management circuit.

FIG. 7 is a block diagram of a sensor signal processing circuit that can be used in an electrokinetic infusion pump with closed loop control according to an additional embodiment of the present invention. The block diagram illustrated in FIG. 7 includes a microprocessor, a digital to analog converter, an analog to digital converter, a voltage nulling device, a voltage amplifier, a position sensor control circuit, a magnetostrictive waveguide, and an electrokinetic infusion pump.

FIG. 8 is an illustration of an electrokinetic infusion pump with closed loop control according to an embodiment of the present invention, that includes an electrokinetic engine and infusion module, which was used to generate basal and bolus delivery of infusion liquid.

FIG. 9 is a graph showing the performance of the electrokinetic infusion pump with closed loop control illustrated in FIG. 8 in both basal and bolus modes.

FIG. 10 is a flow diagram illustrating a method of detecting occlusions in an electrokinetic infusion pump with closed loop control according to an additional embodiment of the present invention.

FIG. 11 is a graph illustrating back pressure in an electrokinetic infusion pump with closed loop control according to an embodiment of the present invention.

FIG. 12 is a graph illustrating the position of a moveable partition as a function of time when an occlusion occurs in an electrokinetic infusion pump with closed loop control according to an embodiment of the present invention.

### DETAILED DESCRIPTION OF EMBODIMENTS OF THE INVENTION

Certain exemplary embodiments will now be described to provide an overall understanding of the principles of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Electrokinetic Infusion Pumps

Electrokinetic pumping can provide the driving force for displacing infusion liquid. Electrokinetic pumping (also known as electroosmotic flow) works by applying an electric potential across an electrokinetic porous media that is filled with electrokinetic solution. Ions in the electrokinetic solution form double layers in the pores of the electrokinetic porous media, countering charges on the surface of the electrokinetic porous media. Ions migrate in response to the electric potential, dragging the bulk electrokinetic solution with them. Electrokinetic pumping can be direct or indirect, depending upon the design. In direct pumping, infusion liquid is in direct contact with the electrokinetic porous media, and is in direct electrical contact with the electrical potential. In indirect pumping, infusion liquid is separated from the electrokinetic porous media and the electrokinetic solution by way of a moveable partition. Further details regarding electrokinetic pumps, including materials, designs, and methods of manufacturing, suitable for use in devices according to the present invention are included in U.S. patent application Ser. Nos. 10/322,083, filed on Dec. 17, 2002, and 11/112,867, filed on Apr. 21, 2005, which are hereby incorporated by reference in their entirety. Other details regarding electrokinetic pumps can also be found in the copending U.S. Patent Application entitled “Electrokinetic Infusion Pump System” (Attorney Docket No.106731-5), which is concurrently filed with the present application.

A variety of infusion liquids can be delivered with electrokinetic infusion pumps using closed loop control, including insulin for diabetes; morphine and/or other analgesics for pain; barbiturates and ketamine for anesthesia; anti-infective and antiviral therapies for AIDS; antibiotic therapies for preventing infection; bone marrow for immunodeficiency disorders, blood-borne malignancies, and solid tumors; chemotherapy for cancer; and dobutamine for congestive heart failure. The electrokinetic infusion pumps with closed loop control can also be used to deliver biopharmaceuticals. Biopharmaceuticals are difficult to administer orally due to poor stability in the gastrointestinal system and poor absorption. Biopharmaceuticals that can be delivered include monoclonal antibodies and vaccines for cancer, BNP-32 (Natrecor) for congestive heart failure, and VEGF-121 for preeclampsia. The electrokinetic infusion pumps with closed loop control can deliver infusion liquids to the patient in a number of ways, including subcutaneously, intravenously, or intraspinally. For example, the electrokinetic infusion pumps can deliver insulin subcutaneously as a treatment for diabetes, or can deliver stem cells and/or sirolimus to the adventitial layer in the heart via a catheter as a treatment for cardiovascular disease.

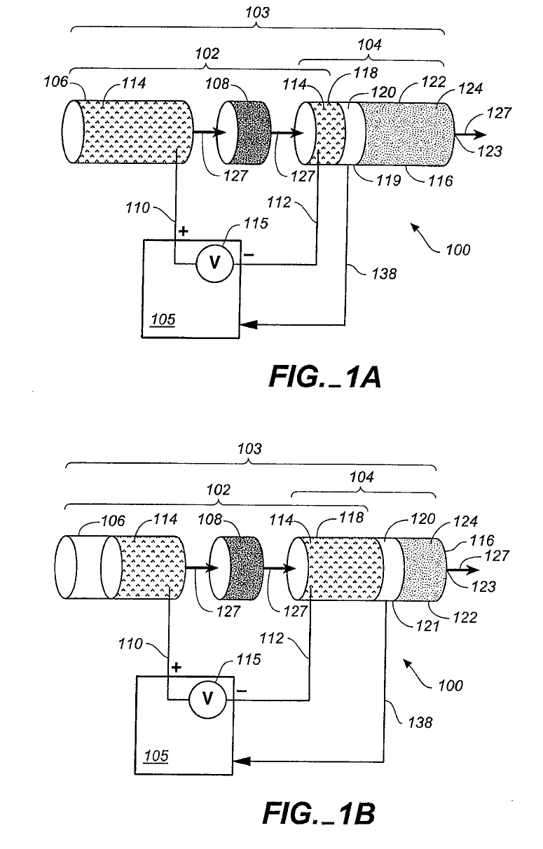

FIGS. 1A and 1B are schematic illustrations of an electrokinetic infusion pump with closed loop control 100 in accord with an exemplary embodiment. The electrokinetic infusion pump system illustrated in FIGS. 1A and 1B includes an electrokinetic infusion pump 103, and a closed loop controller 105. The electrokinetic infusion pump illustrated in FIG. 1A is in a first dispense position, while the pump illustrated in FIG. 1B is in a second dispense position. Electrokinetic infusion pump 103 includes electrokinetic engine 102 and infusion module 104. Electrokinetic engine 102 includes electrokinetic supply reservoir 106, electrokinetic porous media 108, electrokinetic solution receiving chamber 118, first electrode 110, second electrode 112, and electrokinetic solution 114. Closed loop controller 105 includes voltage source 115, and controls electrokinetic engine 102. Infusion module 104 includes infusion housing 116, electrokinetic solution receiving chamber 118, movable partition 120, infusion reservoir 122, infusion reservoir outlet 123, and infusion liquid 124. In operation, electrokinetic engine 102 provides the driving force for displacing infusion liquid 124 from infusion module 104. During fabrication, electrokinetic supply reservoir 106, electrokinetic porous media 108, and electrokinetic solution receiving chamber 118 are filled with electrokinetic solution 114. Before use, the majority of electrokinetic solution 114 is in electrokinetic supply reservoir 106, with a small amount in electrokinetic porous media 108 and electrokinetic solution receiving chamber 118. To displace infusion liquid 124, a voltage is established across electrokinetic porous media 108 by applying potential across first electrode 110 and second electrode 112. This causes electrokinetic pumping of electrokinetic solution 114 from electrokinetic supply reservoir 106, through electrokinetic porous media 108, and into electrokinetic solution receiving chamber 118. As electrokinetic solution receiving chamber 118 receives electrokinetic solution 114, pressure in electrokinetic solution receiving chamber 118 increases, forcing moveable partition 120 in the direction of arrows 127, i.e., the partition 120 is non-mechanically-driven. As moveable partition 120 moves in the direction of arrows 127, it forces infusion liquid 124 out of infusion reservoir outlet 123. Electrokinetic engine 102 continues to pump electrokinetic solution 114 until moveable partition 120 reaches the end nearest infusion reservoir outlet 123, displacing nearly all infusion liquid 124 from infusion reservoir 122.

Once again referring to the electrokinetic infusion pump with closed loop control 100 illustrated in FIGS. 1A and 1B, the rate of displacement of infusion liquid 124 from infusion reservoir 122 is directly proportional to the rate at which electrokinetic solution 114 is pumped from electrokinetic supply reservoir 106 to electrokinetic solution receiving chamber 118. The rate at which electrokinetic solution 114 is pumped from electrokinetic supply reservoir 106 to electrokinetic solution receiving chamber 118 is a function of the voltage and current applied across first electrode 110 and second electrode 112. It is also a function of the physical properties of electrokinetic porous media 108 and the physical properties of electrokinetic solution 114.

In FIG. 1A, movable partition 120 is in first position 119, while in FIG. 1B, movable partition 120 is in second position 121. The position of movable partition 120 can be determined, and used by closed loop controller 105 to control the voltage and current applied across first electrode 110 and second electrode 112. By controlling the voltage and current applied across first electrode 110 and second electrode 112, the rate at which electrokinetic solution 114 is pumped from electrokinetic supply reservoir 106 to electrokinetic solution receiving chamber 118 and the rate at which infusion liquid 124 is pumped through infusion reservoir outlet 123 can be controlled. A closed loop controller can use the position of movable partition 120 to control the voltage and current applied to first electrode 110 and second electrode 112, and accordingly control infusion fluid delivered from the electrokinetic infusion pump.

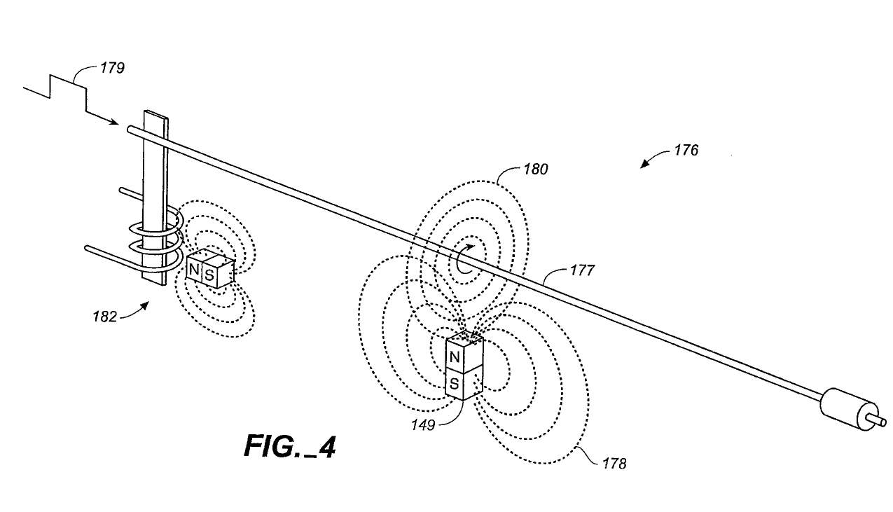

The position of movable partition 120 can be determined using a variety of techniques. In some embodiments, movable partition 120 can include a magnet, and a magnetic sensor can be used to determine its position. FIG. 4 illustrates the principles of one particular magnetic position sensor 176. Magnetic position sensor 176, suitable for use in this invention, can be purchased from MTS Systems Corporation, Sensors Division, of Cary, N.C. In magnetic position sensor 176, a sonic strain pulse is induced in magnetostrictive waveguide 177 by the momentary interaction of two magnetic fields. First magnetic field 178 is generated by movable permanent magnet 149 as it passes along the outside of magnetostrictive waveguide 177. Second magnetic field 180 is generated by current pulse 179 as it travels down magnetostrictive waveguide 177. The interaction of first magnetic field 178 and second magnetic field 180 creates a strain pulse. The strain pulse travels, at sonic speed, along magnetostrictive waveguide 177 until the strain pulse is detected by strain pulse detector 182. The position of movable permanent magnet 149 is determined by measuring the elapsed time between application of current pulse 179 and detection of the strain pulse at strain pulse detector 182. The elapsed time between application of current pulse 179 and arrival of the resulting strain pulse at strain pulse detector 182 can be correlated to the position of movable permanent magnet 149.

Other types of position detectors that include a magnetic sensor for identifying the position of a moveable partition also be used, such as Hall-Effect sensors. In a particular example, anisotropic magnetic resistive sensors can be advantageously used with infusion pumps, as described in the copending U.S. Patent Applications entitled “Infusion Pumps with a Position Sensor” (Attorney Docket No. 106731-18) and “Systems and Methods for Detecting a Partition Position in an Infusion Pump” (Attorney Docket No. 106731-21), both of which are filed concurrently with the present application. In other embodiments, optical components can be used to determine the position of a movable partition. Light emitters and photodetectors can be placed adjacent to an infusion housing, and the position of the movable partition determined by measuring variations in detected light. In still other embodiments, a linear variable differential transformer (LVDT) can be used. In embodiments where an LVDT is used, the moveable partition includes an armature made of magnetic material. A LVDT that is suitable for use in the present application can be purchased from RDP Electrosense Inc., of Pottstown, Pennsylvania. Those skilled in the art will appreciate that other types of position detectors can also be utilized, consistent with embodiments of the present invention.

In alternative embodiments, the amount and/or rate that infusion fluid is dispensed from the pump can be obtained using an appropriate volumetric flow sensor. Suitable flow sensors include thermo-anemometer based sensors, differential pressure sensors, coriolis based mass flow sensors, and the like. Miniaturized sensors (e.g., Micro Electro Mechanical Sensors (MEMS)) are attractive due to their small size and potential low cost, which could allow integration into a dispensable design. When volumetric flow sensors are utilized, an infusion pump need not use a position detector to detect partition position, and subsequently relate that position to an amount of fluid dispensed. By obtaining a direct fluid amount measurement, such sensors can also be utilized to practice the embodiments of the invention discussed herein. For example, such sensors can provide a measured amount value corresponding with a discrete shot of fluid or the amount of fluid dispensed over a given time interval. Accordingly, the sensors can be used to practice techniques such as the closed loop control schemes discussed herein. All these potential variations are within the scope of the present application.

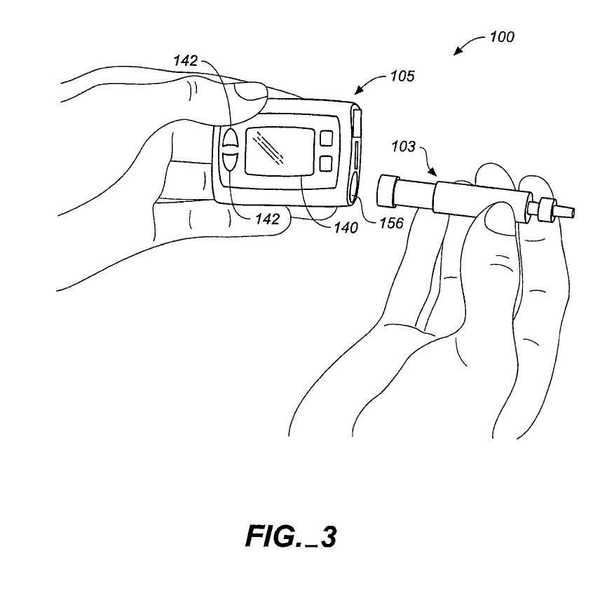

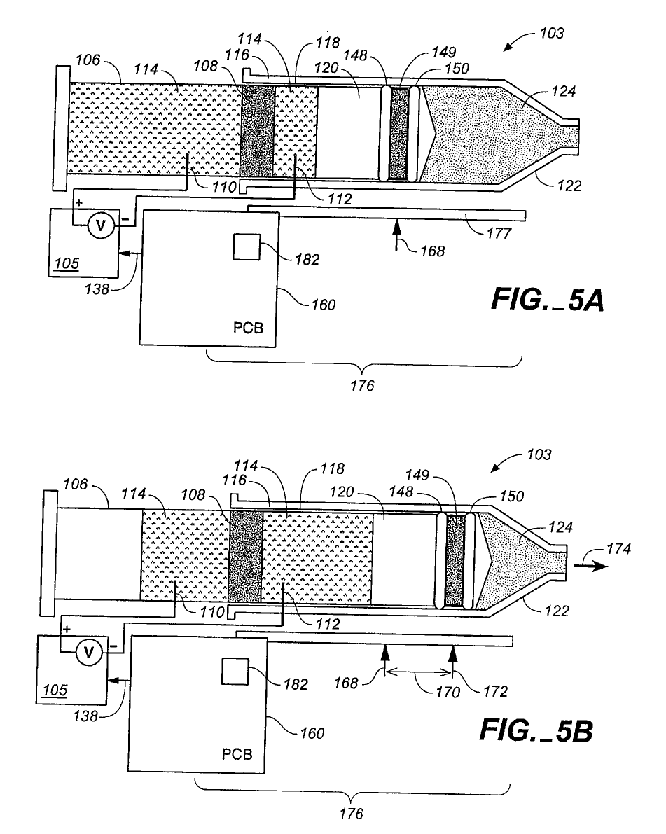

Depending upon desired end use, electrokinetic engine 102 and infusion module 104 can be integrated into a single assembly, or can be separate and connected by tubing. Electrokinetic engine 102 and infusion module 104 illustrated in FIGS. 3, 5A, and 5B are integrated, while electrokinetic engine 102 and infusion module 104 illustrated in FIG. 8 are not integrated. Regardless of whether electrokinetic engine 102 and infusion module 104 are integrated, the position of movable partition 120 can be measured, and used to control the voltage and current applied across electrokinetic porous media 108. In this way, electrokinetic solution 114 and infusion liquid 124 can be delivered consistently in either an integrated or separate configuration.

Electrokinetic supply reservoir 106, as used in the electrokinetic infusion pump with closed loop control illustrated in FIGS. 1A, 1B, 3, 5A, 5B, 7 and 8, can be collapsible, at least in part. This allows the size of electrokinetic supply reservoir 106 to decrease as electrokinetic solution 114 is removed. Electrokinetic supply reservoir 106 can be constructed using a collapsible sack, or can include a moveable piston with seals. Also, infusion housing 116, as used in electrokinetic infusion pump with closed loop control in FIGS. 1A, 1B, 3, 5A, 5B, 7, and 8, is preferably rigid, at least in part. This makes it easier to displace moveable partition 120 than to expand infusion housing 116 as electrokinetic solution receiving chamber 118 receives electrokinetic solution 114 pumped from electrokinetic supply reservoir 106, and can provide more precise delivery of infusion liquid 124. Moveable partition 120 can be designed to prevent migration of electrokinetic solution 114 into infusion liquid 124, while decreasing resistance to displacement as electrokinetic solution receiving chamber 118 receives electrokinetic solution 114 pumped from electrokinetic supply reservoir 106. In some embodiments, moveable partition 120 includes elastomeric seals that provide intimate yet movable contact between moveable partition 120 and infusion housing 116. In some embodiments, moveable partition 120 is piston-like, while in other embodiments moveable partition 120 is fabricated using membranes and/or bellows. As mentioned previously, closed loop control can help maintain consistent delivery of electrokinetic solution 114 and infusion liquid 124, in spite of variations in resistance caused by variations in the volume of electrokinetic supply reservoir 106, by variations in the diameter of infusion housing 116, and/or by variations in back pressure at the user's infusion site.

Closed Loop Control Schemes

Various exemplary embodiments are directed to methods and systems for controlling the delivery of infusion liquids from an electrokinetic infusion pump. In particular embodiments, a closed loop control scheme can be utilized to control delivery of the infusion liquid. Although many of the various closed loop control schemes described in the present application are described in the context of their use with electrokinetic engines, embodiments using other engines are also within the scope of embodiments of the present invention. Closed loop control, as described in the present application, can be useful in many types of infusion pumps. These include pumps that use engines or driving mechanisms that generate pressure pulses in a hydraulic medium in contact with the moveable partition in order to induce partition movement. These driving mechanisms can be based on gas generation, thermal expansion/contraction, and expanding gels and polymers, used alone or in combination with electrokinetic engines. As well, engines in infusion pumps that utilize a moveable partition to drive delivery an infusion fluid (e.g., non-mechanically-driven partitions of an infusion pump such as hydraulically actuated partitions) can include the closed loop control schemes described herein.

Use of a closed loop control scheme with an electrokinetic infusion pump can compensate for variations that may cause inconsistent dispensing of infusion liquid. For example, with respect to FIGS. 1A and 1B, if flow of electrokinetic solution 114 varies as a function of the temperature of electrokinetic porous media 108, variations in the flow of infusion liquid 124 can occur if a constant voltage is applied across first electrode 110 and second electrode 112. By using closed loop control, the voltage across first electrode 110 and second electrode 112 can be varied based upon the position of movable partition 120 and the desired flow of infusion liquid 124. Another example of using closed loop control involves compensating for variations in flow caused by variations in down stream resistance to flow. In cases where there is minimal resistance to flow, lower voltages and current may be used to achieve a desired flow of electrokinetic solution 114 and infusion liquid 124. In cases where there is higher resistance to flow, higher voltages and current may be used to achieve a desired flow of electrokinetic solution 114 and infusion liquid 124. Since resistance to flow is often unknown and/or changing, variations in flow of electrokinetic solution 114 and infusion liquid 124 may result. By determining the position of movable partition 120, the current and voltage can be adjusted to deliver a desired flow rate of electrokinetic solution 114 and infusion liquid 124, even if the resistance to flow is changing. Another example of using closed loop control involves compensating for variation in flow caused by variation in the force required to push movable partition 120. Variations in friction between movable partition 120 and the inside surface of infusion housing 116 may cause variations in the force required to push movable partition 120. If a constant voltage and current are applied across electrokinetic porous media 108, variation in flow of electrokinetic solution 114 and infusion liquid 124 may result. By monitoring the position of movable partition 120, and varying the voltage and current applied across electrokinetic porous media 108, a desired flow rate of electrokinetic solution 114 and infusion liquid 124 can be achieved. Accordingly, in some embodiments, a closed loop control algorithm can utilize a correction factor, as discussed herein, to alter operation of a pump (e.g., using the correction factor to change the current and/or voltage applied across the electrokinetic pump's electrodes).

Electrokinetic infusion pumps that utilize a closed loop control scheme can operate in a variety of manners. For example, the pump can be configured to deliver a fluid shot amount in a continuous manner (e.g., maintaining a constant flow rate) by maintaining one or more pump operational parameters at a constant value. Non-limiting examples include flow rate of infusion fluid or electrokinetic solution, pressure, voltage or current across electrodes, and power output from a power source. In such instances, a closed loop control scheme can be used to control the operational parameter at or near the desired value.

In some embodiments, the pump is configured to deliver an infusion fluid by delivering a plurality of fluid shot amounts. For example, the electrokinetic infusion pump can be configured to be activated to deliver a shot amount of fluid. The amount can be determined using a variety of criteria such as a selected quantity of fluid or application of a selected voltage and/or current across the electrodes of the pump for a selected period of time. Following activation, the pump can be deactivated for a selected period of time, or until some operating parameter reaches a selected value (e.g., pressure in a chamber of the electrokinetic pump). Continuous cycles of activation/deactivation can be repeated, with each cycle delivering one of the fluid shot amounts. An example of such operation is discussed herein. Closed loop control schemes can alter one or more of the parameters discussed with respect to an activation/deactivation cycle to control delivery of the infusion fluid. For instance, the shot duration of each shot can be altered such that a selected delivery rate of infusion fluid from the pump is achieved over a plurality of activation/deactivation cycles. Alteration of shot durations during activation/deactivation cycles can be utilized advantageously for the delivery of particular infusion fluids such as insulin. For example, diabetic patients typically receive insulin in two modes: a bolus mode where a relatively large amount of insulin can be dosed (e.g., just before a patient ingests a meal), and a basal mode where a relatively smaller, constant level of insulin is dosed to maintain nominal glucose levels in the patient. By utilizing activation/deactivation cycles, both delivery modes can easily be accommodated by simply adjusting the shot duration (e.g., very short shots during basal delivery and one or more longer shots for a bolus delivery) and/or the deactivation duration.

Another potential advantage to operating under repeated activation/deactivation cycles is that such an operation prevents too much infusion fluid from being released at once. Take, for example, an infusion pump operating at a constant delivery rate (i.e., not a continuous activation/deactivation cycle). If such an infusion pump becomes occluded, a closed loop controller could potentially continue to try and advance the plunger, causing the pressure to rise in the infusion set with little change in fluid delivery. Thus, if the occlusion is suddenly removed, the stored pressure could inject a potentially hazardous and even lethal dose of infusion fluid into the patient. Electrokinetic infusion pumps operating under a repeated cycle of activation and deactivation can reduce the risk of overdose by allowing the pressure stored within the infusion set to decrease over time due to leakage back through the electrokinetic porous material. Accordingly, some of the embodiments discussed herein utilize an infusion pump operating with an activation/deactivation cycle.

Another potential advantage of utilizing continuous activation/deactivation cycles is that such cycles can help an electrokinetic pump avoid potential mechanical inefficiencies. For example, with respect to insulin delivery in the basal mode, a very small pressure may be associated with infusing insulin at a slow rate. Very low pressures, however, may result in mechanical inefficiencies with pump movement. For example, smooth partition/piston movement may require a threshold pressure that exceeds the low pressure needed to infuse insulin at the designated basal rate, otherwise sporadic movement may result, leading to difficulties in pump control. By utilizing activation/deactivation cycles, a series of relatively small “microboluses” can be released, sufficiently spaced in time, to act as a virtual basal delivery. Each microbolus can use a high enough pressure to avoid the mechanical inefficiencies.

Some embodiments are directed to methods of controlling fluid delivery from an electrokinetic infusion pump. The electrokinetic infusion pump can be configured to deliver one or more fluid shot amounts. For example, the pump can deliver a single continuous fluid shot amount, consistent with continuous operation. Alternatively, a plurality of fluid shot amounts can be delivered as in a series of activation/deactivation cycles. One or more measured amounts can be determined for the plurality of shot amounts. For example, a measured amount can be obtained for each of a plurality of fluid shots, or after a selected number of fluid shots when a pump operates utilizing a series of activation/deactivation cycles. In another example, a series of measured amounts can be determined for a single continuous shot, corresponding to determining the amount of fluid displaced from the pump over a series of given time intervals during continuous fluid dispensing. Fluid shot amounts and measured amounts can be described by a variety of quantities that denote an amount of fluid. Though volume is utilized as a unit of shot amount in some embodiments, non-limiting other examples include mass, a length (e.g., with an assumption of some cross-sectional area), or a rate (e.g., volumetric flow rate, flux, etc.). An average measured amount can be calculated from the measured amounts, and subsequently used to calculate a correction factor. The correction factor can also depend upon an expected amount, which is either selected by a pump user or designated by a processor or controller of the pump. The correction factor can be used to adjust subsequent fluid delivery from the pump (e.g., used to adjust a subsequent fluid shot amount from the pump). Such subsequent fluid delivery can be used to correct for previous over-delivery or under-delivery of infusion fluid, or to deliver the expected amount.

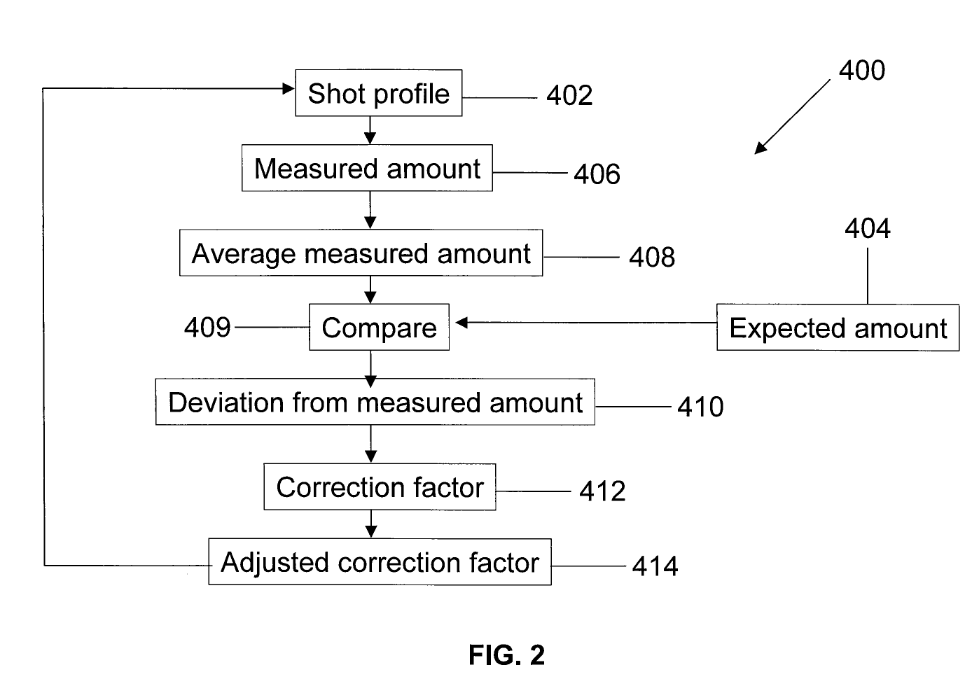

During pump operation, as fluid is delivered, the steps of determining a measured amount; calculating an average measured amount; calculating a correction factor; and adjusting subsequent fluid delivery based at least in part on the correction factor, can be serially repeated (e.g., after each fluid shot, or after a selected plurality of fluid shots when using activation/deactivation cycles) to control dispensing of fluid from the pump. A more specific example of the implementation of these methods is described with respect to FIG. 2 herein.

FIG. 2 is a flow sheet illustrating a closed loop control algorithm 400 for use with an electrokinetic infusion pump having closed loop control, according to an embodiment of the present invention. The immediate following description herein assumes that the pump utilizes activation/deactivation cycles. Accordingly measured amounts are referred to as measured shot amounts, average measured amounts are referred to as average shot amounts, and expected amounts are referred to as expected shot amounts. It is understood, however, that the embodiment can also be utilized with a pump operating in a continuous delivery mode as described below.

With reference to FIGS. 1A, 1B, and 2, closed loop control algorithm 400 starts with an initial shot profile 402, i.e., activation of the electrokinetic pump to cause a shot of infusion fluid to be dispensed therefrom. The shot profile can be chosen to provide an expected shot fluid amount to be dispensed from the pump. In one example, shot profile 402 includes application of voltage across first electrode 110 and second electrode 112 for a selected length of time. The voltage is referred to as shot voltage, and the time is referred to as shot duration. Although one can vary shot voltage or shot duration (among other operational variables) in closed loop control algorithms, in this description, shot duration is varied.

Returning to FIG. 2, in shot profile 402, shot voltage is applied for a shot duration, resulting in a delivered amount intended to correspond with an expected shot amount 404. In one particular example, shot amounts are designated by volume. Therefore, the expected shot amount 404 is an expected shot volume. Next a corresponding measured shot volume 406 is measured. The measured shot volume can be identified by any number of techniques. For example, by measuring the displacement of movable partition 120 during a shot profile, and knowing the cross-sectional area of a fluid reservoir, measured shot volume 406 can be determined. The displacement of the moveable partition can be determined using any number of position sensors, including those described herein.

When a position sensor is implemented, the particular technique used to measure the position of movable partition 120 can have a direct effect upon the precision and accuracy of measured shot volume 406, and, accordingly, upon closed loop control algorithm 400. In particular, if sampling of a position sensor's movement between shots is such that the actual displacement is of the order of the resolution of the position sensor, shot-to-shot precision can be difficult to maintain with a closed loop control scheme that only utilizes the last two measured shot amounts to calculate a correction factor. Other sources of error can also adversely affect the shot-to-shot precision (e.g., either random errors or systematic errors that cause a drift in an operating parameter such as fluid output over a period of time). To improve the precision and accuracy of closed loop control algorithm 400, measured shot volume 406 can be combined with previous measurements to calculate an average measured shot volume 408, which can be used in the closed loop control algorithm 400.

The average measured shot volume (or shot amount) can be calculated in a variety of manners. For example, the average measured shot volume can be calculated using all previously measured shot volumes, or a subset of all measured volumes (e.g., utilizing a moving average where the last N measured volumes are utilized in the calculation, N being a selected value). As well, a number of ways can be employed to calculate the average. One way of calculating an average measured shot volume is to simply calculate the arithmetic mean of some designated number of the measured shot volumes. Another way of calculating an average measured shot volume is to calculate the weighted cumulative average of all measured shot volumes. When calculating the weighted average of a designated number of measured shot volumes, one or more weighting factors can be multiplied by a corresponding measured shot volume, and the products summed to form the weighted average. The weighting factors can be normalized either before or after the summation is calculated. Weighting factors can be chosen in a variety of manners, including manners understood by those skilled in the art, to provide an average shot volume having a desired characteristic. For example, when all the weighting factors have the same value, the calculated average can essentially be the arithmetic mean.

In some embodiments, the weighted average can be calculated using one or more weighting factors such that one or more later measured shot amounts are weighted more heavily than one or more earlier measured shot amounts. In a particular embodiment in which later shot amounts are weighted more heavily, a weighting factor, ε, is utilized with each new measured shot volume to create a new average shot volume based on a previously calculated average shot volume. For a calculation utilizing n measured shot volumes, the weighted average is determined by multiplying a new measured shot volume by a weighting factor, ε, and adding the product to the previously calculated weighted cumulative average of all n measured shot volumes, and the sum is divided by the quantity of ε+1. For the n^{th} weighted cumulative average of all measured shot volumes, this is

$${average}_{n} = \frac{( ɛ \times {vol}_{n , meas} ) + {average}_{n - 1}}{ɛ + 1}$$

where averageₙ is the new weighted cumulative average of all n measured shot volumes, ε is a weighting factor, vol_{n,means} is the n^{th} measured shot volume, and averageₙ₋₁ is the previously calculated weighted cumulative average of all n−1 measured shot volumes. Note that average₁ is set equal to vol_{1,meas}. Using weighting factor ε, the new measured shot volume can be weighted more than earlier measured shot volumes, allowing more weighting for newer variations in the measured shot volume than in previously measured shot volumes. Those skilled in the art will realize that the aforementioned technique of calculating a weighted average can also be performed in a number of other manners. Non-limiting examples include calculating each average using all the measured shot volumes (e.g., not using a previously calculated average value); applying the algorithm to measure shot amounts on a different unit basis (e.g., using the algorithm to calculated expected and measured movable partition position); and choosing different techniques to weight a later measured value. All of these variations are within the scope of the present application.

Returning to FIG. 2, the deviation from expected shot volume 410 can be determined by comparing 409 the average measured shot volume 408 to the expected shot volume 404. The deviation from expected shot volume 410 can then be used to calculate a correction factor 412 , which can be applied to adjust a subsequent shot profile 402. In this description, the correction factor 412 is typically some value indicative of the deviation between an expected shot amount and an average shot amount. For example the correction factor 412 can be set equal to the deviation value. In another example, the correction factor 412 can be the deviation multiplied by a proportional adjustment such as a designated fraction, referred to as λ, resulting in an adjusted correction factor 414. For example, if λ=0.4, then 40 percent of deviation is applied in calculating the subsequent shot profile. Application of adjusted correction factor 414 results in a subsequent shot profile 402, and the algorithm is repeated, i.e., the adjusted correction factor is used to determine some operating pump parameter such as voltage, current, or shot duration to provide the subsequent shot profile.

In one embodiment, several measured shot volumes are determined and averaged before making corrections to shot profile 402. Henceforth, closed loop control algorithm 400 can be used to adjust shot profile 402. Closed loop control algorithm 400 can be particularly useful when electrokinetic infusion pump with closed loop control 100 is delivering infusion liquid 124 in basal mode, as is described in the Examples discussed below.

As noted earlier, the description of FIG. 2 above is with respect to an infusion pump utilizing activation/deactivation cycles. It is understood that the various steps shown in FIG. 2 can also be practiced by a pump operating by delivering a single continuous shot, or multiple semi-continuous shots. For example, the shot profile 402 can be a continuous delivery of infusion fluid (e.g., at a selected basal delivery rate with intermittent increases for bolus delivery). A measured amount 406 can be obtained and correspond with an amount of dispensed fluid over a selected time interval. A series of previously measured amounts, each corresponding with particular time intervals that can be equal in time length, can be used to calculate an average measured amount 408; the average measured amount can be calculated using any of the techniques discussed herein (e.g., use of one or more weighting factors). The average measured amount can be compared 409 with an expected amount 404 (e.g., an amount of fluid expected to be dispensed over the time length), and a deviation between the two values noted 410. Subsequently, the correction factor 412 can be calculated using any of the techniques discussed herein, including an adjusted correction factor 414 if desired. The factor can be used subsequently to adjust the shot profile 402 as desired (e.g., increase or decrease the flow rate for basal delivery).

Though some of the closed loop control schemes discussed herein are described with respect to controlling fluid flow from an infusion pump, such schemes can also, or alternatively, be used to detect an occlusion or fluid-leak in an infusion pump. In particular, the presence of bubbles, other obstructions that interfere with flow from an infusion pump, or an infusion pump disconnect can be detected in a pump in conjunction with closed loop control. For example, if a moveable partition of an infusion pump does not move as expected in a given operational mode, the deviation in movement can be used as an indicator of the presence of a pump malfunction. Use of a closed loop control scheme to detect occlusions is described with reference to one of the Examples discussed herein. Other details regarding the techniques for detecting malfunctions in an infusion pump can be found in the copending U.S. Patent Applications entitled “Malfunction Detection via Pressure Pulsation” (Attorney Docket No. 106731-6) and “Malfunction Detection with Derivative Calculation” (Attorney Docket No. 106731-22), which are concurrently filed with the present application. Those skilled in the art will appreciate that other closed loop control schemes can also be implemented to provide malfunction detection (e.g., occlusions and fluid-leaks) within the scope of the present application's disclosure.

Electrokinetic Infusion Pump with Closed Loop Controller

FIG. 3 is an illustration of an electrokinetic infusion pump with closed loop control 100 according to an exemplary embodiment of the present invention. Electrokinetic infusion pump with closed loop control 100 includes closed loop controller 105 and electrokinetic infusion pump 103. In the embodiments of electrokinetic infusion pump with closed loop control 100 illustrated in FIGS. 3, 5A, 5B, 7, and 8 electrokinetic infusion pump 103 and closed loop controller 105 can be handheld, or mounted to a user by way of clips, adhesives, or non-adhesive removable fasteners. Closed loop controller 105 can be directly or wirelessly connected to remote controllers that provide additional data processing and/or analyte monitoring capabilities. As outlined earlier, and referring to FIGS. 1 and 2, closed loop controller 105 and electrokinetic infusion pump 103 can include elements that enable the position of movable partition 120 to be determined. Closed loop controller 105 includes display 140, input keys 142, and insertion port 156. After filling electrokinetic infusion pump 103 with infusion liquid 124, electrokinetic infusion pump 103 is inserted into insertion port 156. Upon insertion into insertion port 156, electrical contact is established between closed loop controller 105 and electrokinetic infusion pump 103. An infusion set is connected to the infusion reservoir outlet 123 after electrokinetic infusion pump 103 is inserted into insertion port 156, or before it is inserted into insertion port 156. Various means can be provided for priming of the infusion set, such as manual displacement of moveable partition 120 towards infusion reservoir outlet 123. After determining the position of moveable partition 120, voltage and current are applied across electrokinetic porous media 108, and infusion liquid 124 is dispensed. Electrokinetic infusion pump with closed loop control 100 can be worn on a user's belt providing an ambulatory infusion system. Display 140 can be used to display a variety of information, including infusion rates, error messages, and logbook information. Closed loop controller 105 can be designed to communicate with other equipment, such as analyte measuring equipment and computers, either wirelessly or by direct connection.

FIGS. 5A and 5B illustrate portions of an electrokinetic infusion pump with closed loop control according to an embodiment of the present invention. FIGS. 5A and 5B include electrokinetic infusion pump 103, closed loop controller 105, magnetic position sensor 176, and position sensor control circuit 160. Position sensor control circuit 160 is connected to closed loop controller 105 by way of feedback 138. Electrokinetic infusion pump 103 includes infusion housing 116, electrokinetic supply reservoir 106, electrokinetic porous media 108, electrokinetic solution receiving chamber 118, infusion reservoir 122, and moveable partition 120. Moveable partition 120 includes first infusion seal 148, second infusion seal 150, and moveable permanent magnet 149. Infusion reservoir 122 is formed between moveable partition 120 and the tapered end of infusion housing 116. Electrokinetic supply reservoir 106, electrokinetic porous media 108, and electrokinetic solution receiving chamber 118 contain electrokinetic solution 114, while infusion reservoir 122 contains infusion liquid 124. Voltage is controlled by closed loop controller 105, and is applied across first electrode 110 and second electrode 112. Magnetic position sensor 176 includes magnetostrictive waveguide 177, position sensor control circuit 160, and strain pulse detector 182. Magnetostrictive waveguide 177 and strain pulse detector 182 are typically mounted on position sensor control circuit 160.

In FIG. 5A, moveable partition 120 is in first position 168. Position sensor control circuit 160 sends a current pulse down magnetostrictive waveguide 177, and by interaction of the magnetic field created by the current pulse with the magnetic field created by moveable permanent magnet 149, a strain pulse is generated and detected by strain pulse detector 182. First position 168 can be derived from the time between initiating the current pulse and detecting the strain pulse. In FIG. 5B, electrokinetic solution 114 has been pumped from electrokinetic supply reservoir 106 to electrokinetic solution receiving chamber 118, pushing moveable partition 120 toward second position 172. Position sensor control circuit 160 sends a current pulse down magnetostrictive waveguide 177, and by interaction of the magnetic field created by the current pulse with the magnetic field created by moveable permanent magnet 149, a strain pulse is generated and detected by strain pulse detector 182. Second position 172 can be derived from the time between initiating the current pulse and detecting the strain pulse. Change in position 170 can be determined using the difference between first position 168 and second position 172. As mentioned previously, the position of moveable partition 120 can be used in controlling flow in electrokinetic infusion pump 103.

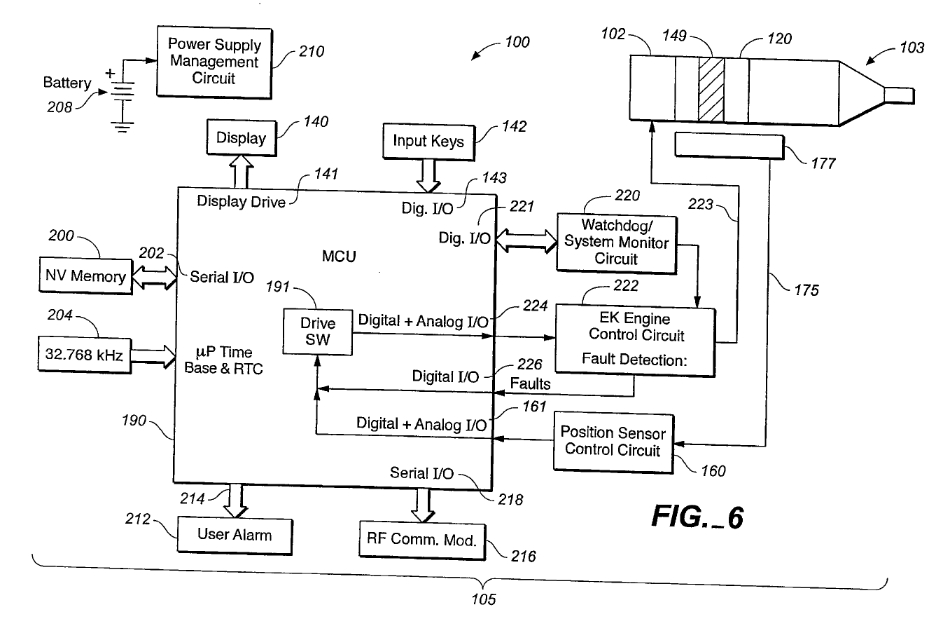

FIG. 6 is a block diagram of a circuit that can be used as part of a controller in an electrokinetic infusion pump with closed loop control according to an additional embodiment of the present invention. Electrokinetic infusion pump 103 includes electrokinetic engine 102, and moveable partition 120. Electrokinetic engine 102 displaces moveable partition 120 by pumping electrokinetic solution 114 (not shown) against moveable partition 120. Moveable partition 120 includes moveable permanent magnet 149. The position of moveable permanent magnet 149 in electrokinetic infusion pump 103 is detected by magnetostrictive waveguide 177. Although in this illustration magnetic techniques are used to determine the position of moveable partition 120, other types of position sensors that emit a signal identifying a position of a moveable partition can also be used, as mentioned previously. Other techniques include the use of light emitters, photodetectors, and anisotropic magnetic resistive sensors. Electrokinetic infusion pump with closed loop control 100 includes master control unit 190 and master control software 191. Master control unit 190 and master control software 191 control various elements in electrokinetic infusion pump with closed loop control 100, including display 140, input keys 142, non-volatile memory 200, system clock 204, user alarm 212, radio frequency communication circuit 216, position sensor control circuit 160, electrokinetic engine control circuit 222, and system monitor circuit 220. Battery 208 powers master control unit 190, and is controlled by power supply and management circuit 210. User alarm 212 can be audible, vibrational, or optical.

Master control unit 190 can be mounted to a printed circuit board and includes a microprocessor. Master control software 191 controls the master control unit 190. Display 140 provides visual feedback to users, and is typically a liquid crystal display, or its equivalent. Display driver 141 controls display 140, and is an element of master control unit 190. Input keys 142 allow the user to enter commands into closed loop controller 105 and master control unit 190, and are connected to master control unit 190 by way of digital input and outputs 143. Non-volatile memory 200 provides memory for closed loop controller 105, and is connected to master control unit 190 by way of serial input and output 202. System clock 204 provides a microprocessor time base and real time clock for master control unit 190. User alarm 212 provides feedback to the user, and can be used to generate alarms, warnings, and prompts. Radio frequency communication circuit 216 is connected to master control unit 190 by way of serial input and output 218, and can be used to communicate with other equipment such as self monitoring blood glucose meters, electronic log books, personal digital assistants, cell phones, and other electronic equipment. Information that can be transmitted via radio frequency, or with other wireless methods, include pump status, alarm conditions, command verification, position sensor status, and remaining power supply. Position sensor control circuit 160 is connected to master control unit 190 by way of digital and analog input and output 161, and is connected to magnetostrictive waveguide 177 by way of connector 175. As discussed previously, position sensor control circuit 160 uses magnetostrictive waveguide 177 and moveable permanent magnet 149 to determine the position of moveable partition 120. Electrokinetic engine control circuit 222 is connected to master control unit 190 by way of digital and analog input and output 224, and to electrokinetic engine 102 by way of connector 223. Electrokinetic engine control circuit 222 controls pumping of electrokinetic solution 114 and infusion liquid 124, as mentioned previously. Electrokinetic engine control circuit 222 relies upon input from position sensor control circuit 160, and commands issued by master control unit 190 and master control software 191, via digital and analog input and output 224. Fault detection in electrokinetic engine control circuit 222 is reported to master control unit 190 and master control software 191 by way of digital input and output 226. System monitor circuit 220 routinely checks for system faults, and reports status to master control unit 190 and master control software 191 by way of digital input and output 221. Battery 208 provides power to master control unit 190 and is controlled by power supply and management circuit 210.

Embodiments of the invention can utilize a closed loop controller configured to control delivery of a fluid shot amount from the electrokinetic infusion pump. In the particular embodiment shown in FIG. 6, the master control software 191 can be programmed to control fluid release from the electrokinetic infusion pump 103. In particular, a controller can be configured to implement any of the closed loop control schemes described within the present application. Accordingly, a controller can be configured to control delivery of a fluid shot amount from an infusion pump based at least in part upon an expected amount and an average measured amount calculated from a plurality of previously measured amounts. Such measured amounts can be obtained from a position detector (e.g., a magnetic position sensor). The controller (e.g., the software and processor) can also be configured to calculate the average measured amount using any of the methods described herein, for example a weighted average that more heavily weights recently obtained measured amounts. All possible variations of the features of closed loop control schemes described herein (e.g., those described with respect to the flow chart of FIG. 2) can be implemented in such a controller. Those skilled in the art will appreciate that implementation of a controller need not follow the exact embodiment shown in FIG. 6. Indeed, hardwire circuitry and have embedded software that is configured to carry one or more or all of the instructions necessary to implement a particular closed loop control scheme. Furthermore, one or more separate processors or separate hardware control units can be combined as a “controller” consistent with embodiments of the invention described herein. As well, a “controller” can include memory units that are read-only or capable of being overwritten to hold parameters such as selected values or control parameters (e.g., the number of measured amounts used in an averaging calculation, an expected amount, a fractional value of the deviation used in a correction factor, etc.). All these variations, and others, are within the scope of the disclosure of the present application.

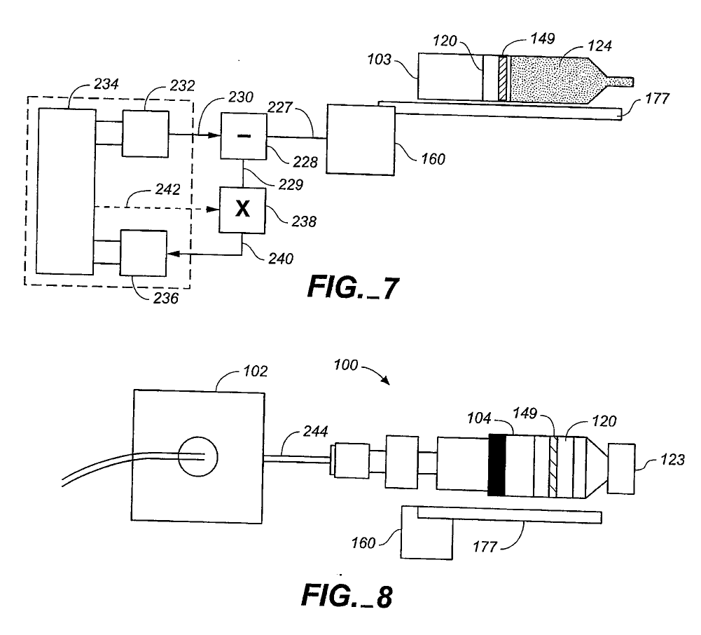

FIG. 7 is a block diagram of a position sensor signal processing circuit that can be used in an electrokinetic infusion pump with closed loop control according to an additional embodiment of the present invention. The block diagram illustrated in FIG. 7 includes electrokinetic infusion pump 103, magnetorestrictive waveguide 177, position sensor control circuit 160, voltage nulling device 228, voltage amplifier 238, digital to analog converter 232, analog to digital converter 236, and microprocessor 234. Electrokinetic infusion pump 103 includes moveable partition 120 and infusion liquid 124. Moveable partition 120 includes moveable permanent magnet 149, which interacts with magnetostricitive waveguide 177 in determining the position of moveable partition 120 in electrokinetic infusion pump 103. When the position sensor signal processing circuit illustrated in FIG. 7 is used, the resolution of magnetostricitive waveguide 177 is increased. In operation, magnetostricitive waveguide 177 yields a voltage that varies as a function of the position of moveable permanent magnet 149. When the position sensor signal processing circuit illustrated in FIG. 7 is not used, the voltage from magnetostrictive waveguide 177 ranges from 0 to a maximum value that is determined by analog to digital converter 236. For a given resolution of the analog to digital converter, the resolution of magnetostrictive waveguide 177 is determined by the maximum voltage that analog to digital converter 236 can process divided by the length of magnetostrictive waveguide 177.

When the position sensor signal processing circuit illustrated in FIG. 7 is used, voltage nulling device 228 can offset the voltage from magnetostricitive waveguide 177 to either zero, or a value near zero. After the voltage from magnetostrictive waveguide 177 is offset by voltage nulling device 228, nulled voltage 229 can be multiplied using voltage amplifier 238 to a value less than the maximum voltage that can be processed by analog to digital converter 236. The combined effect of nulling device 228 and voltage amplifier 238 is to divide the maximum voltage that can be processed by analog to digital converter 236 by a smaller length, and in that way increase the voltage change per unit length of movement by moveable permanent magnet 149. To avoid exceeding the capacity of analog to digital converter 236, the nulling step can be repeated by voltage nulling device 228 multiple times as moveable partition 120 moves along the length of electrokinetic infusion pump 103. Larger voltage change per unit length of movement by moveable permanent magnet 149 allows smaller detectable volumes, and more sensitive determination of the position of moveable permanent magnet 149, for a given resolution of the analog to digital converter 236. Upon insertion of electrokinetic infusion pump 103 into closed loop controller 105, an amplification factor of approximately 1 can be used by voltage amplifier 238, with a nulling voltage of 0 volts. Once moveable permanent magnet 149 moves from its original position, voltage nulling device 228 can apply nulling voltage that results in a nulled voltage of approximately zero, and voltage amplifier 238 can amplify the voltage, while keeping the voltage in the range of analog to digital converter 236. If power to closed loop controller 105 is inadvertently lost, the nulling voltage and amplification factor can be recovered from non-volatile memory 200, if it has been previously stored. In alternative embodiments, a fixed amplification factor can be used, and the nulling voltage varied to keep the voltage within the range of analog to digital converter 236.

As mentioned previously, when designing an electrokinetic infusion pump with closed loop control 100, the infusion module 104 and the electrokinetic engine 102 can be integrated, as illustrated in FIGS. 3, 5A, 5B, and 7, or they can be separate components connected with tubing, as illustrated in FIG. 8. In FIG. 8, electrokinetic infusion pump with closed loop control 100 includes infusion module 104 and electrokinetic engine 102, connected by connection tubing 244. Infusion module 104 includes moveable partition 120 and infusion reservoir outlet 123. Moveable partition 120 includes moveable permanent magnet 149. Further details regarding electrokinetic engine 102, including materials, designs, and methods of manufacturing, suitable for use in electrokinetic infusion pump with closed loop control 100 are included in U.S. patent application Ser. No. 10/322,083, previously incorporated by reference.

It should be understood that various alternatives to the embodiments of the invention described herein may be employed in practicing the invention. It is intended that the following claims define the scope of the invention and that structures within the scope of these claims and their equivalents be covered thereby.

### EXAMPLES

The following examples are provided to illustrate some aspects of the present application. The examples, however, are not intended to limit the scope of any embodiment of the invention.

### Example 1

### Basal and Bolus Liquid Delivery

Using an electrokinetic infusion pump with closed loop control 100 as illustrated in FIG. 8, basal and bolus infusion liquid delivery rates were determined. In basal infusion, small volumes are dispensed as a series of shots. In bolus infusion, large volumes are dispensed in a single shot of longer duration. Basal and bolus infusion liquid delivery rates were determined by applying voltage to electrokinetic engine 102 for a period of time (referred to as the pump on time), then switching the voltage off for a period of time (referred to as the pump off time). The sum of pump on time and pump off time is referred to as cycle time in this example. The mass of infusion liquid pumped during each cycle time (referred to as the shot size) was determined with a Mettler Toledo AX205 electronic balance. The shot size was determined repeatedly, using the same pump on time and the same cycle time, giving an indication of shot size repeatability. Using the density of water (about 1 gram per cubic centimeter), the shot size volume was derived from the mass of infusion liquid pumped during each cycle time.

Electrokinetic engine 102 was connected to infusion module 104 using connection tubing 244. Connection tubing 244 was rigid PEEK tubing with an inside diameter of 0.040″, an outside diameter of 0.063″, and a length of approximately 3″. A similar piece of PEEK tubing, approximately 24″ long, was connected to infusion reservoir outlet 123 on one end, and to glass capillary tubing on the other end. The glass capillary tubing had an inside diameter of 0.021″, an outside diameter of 0.026″, and a length of about 6″. The end of the glass capillary tubing, which was not connected to infusion reservoir outlet 123, was inserted into a small vial being weighed by the Mettler Toledo AX205 electronic balance. A small amount of water was placed in the bottom of the small vial, covering the end of the glass capillary tubing, and a drop of oil was placed on top of the water in the bottom of the small vial to reduce evaporation of the water. Electrokinetic engine 102 was also connected to a vented electrokinetic solution reservoir (not shown in FIG. 8) that provided electrokinetic solution to electrokinetic engine 102. Electrokinetic engine 102, vented electrokinetic solution reservoir, infusion module 104, connection tubing 244, the glass capillary tubing, and the Mettler Toledo AX205 electronic balance, were placed inside a temperature-controlled box, held to +/−1° C., to eliminate measurement errors associated with temperature variations. The temperature-controlled box was placed on top of a marble table to reduce errors from vibration. A personal computer running LabView software controlled electrokinetic infusion pump with closed loop control 100 and collected data from the Mettler Toledo AX205 electronic balance.

To determine basal delivery of infusion liquid, electrokinetic engine 102 was connected to infusion module 104 with connection tubing 244 and driven with a potential of 75V. At 75V, electrokinetic engine 102 delivered electrokinetic solution to infusion module 104 at a rate of approximately 15 microliters/minute. Electrokinetic engine 102 was run with an on time of approximately 2 seconds and an off time of approximately 58 seconds, resulting in a cycle time of 60 seconds and a shot size of approximately 0.5 microliters. The on-time of electrokinetic engine 102 was adjusted, based upon input from magnetostrictive waveguide 177 and position sensor control circuit 160, which ran a closed loop control algorithm in accord with the description of FIG. 2. For each cycle of basal delivery, the position of moveable permanent magnet 149 was determined. If moveable permanent magnet 149 did not move enough, the on time for the next cycle of basal delivery was increased. If moveable permanent magnet 149 moved too much, the on time for the next cycle of basal delivery was decreased. The determination of position of moveable permanent magnet 149, and any necessary adjustments to on time, was repeated for every cycle of basal delivery.

To determine bolus delivery of infusion liquid, electrokinetic engine 102 was connected to infusion module 104 with connection tubing 244 and driven with a potential of 75V. Once again, at 75V electrokinetic engine 102 delivered electrokinetic solution to infusion module 104 at a rate of approximately 15 microliters/minute. Electrokinetic engine 102 was run with an on time of approximately 120 seconds and an off time of approximately 120 seconds, resulting in a cycle time of 4 minutes and a shot size of approximately 30 microliters. For each cycle of bolus delivery, the position of moveable permanent magnet 149 was determined while the electrokinetic engine 102 was on. Once moveable permanent magnet 149 moved the desired amount, electrokinetic engine 102 was turned off. The position of moveable permanent magnet 149 was used to control on time of electrokinetic engine 102 for every cycle of bolus delivery.

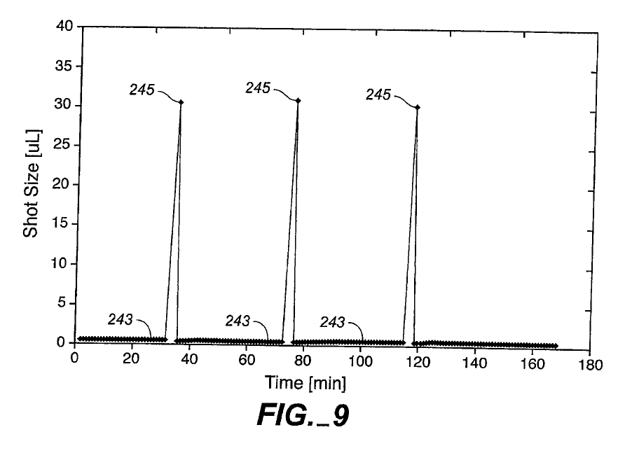

Basal and bolus delivery of infusion liquid were alternated, as follows. Thirty cycles of basal delivery was followed by one cycle of bolus delivery. Then, thirty-seven cycles of basal delivery, was followed by one cycle of bolus delivery. Finally, thirty-eight cycles of basal delivery was followed by a one cycle of bolus delivery and forty-nine additional cycles of basal delivery. FIG. 9 is a graph showing measured shot size as a function of time, for alternating basal delivery 243 and bolus delivery 245, as outlined above. In basal mode, the average shot size was about 0.5 microliters with a standard deviation of less than 2%.

### Example 2

### Occlusion Detection with Closed Loop Control

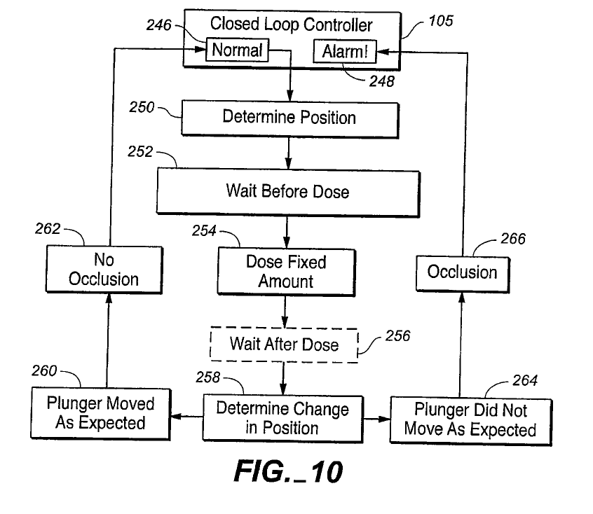

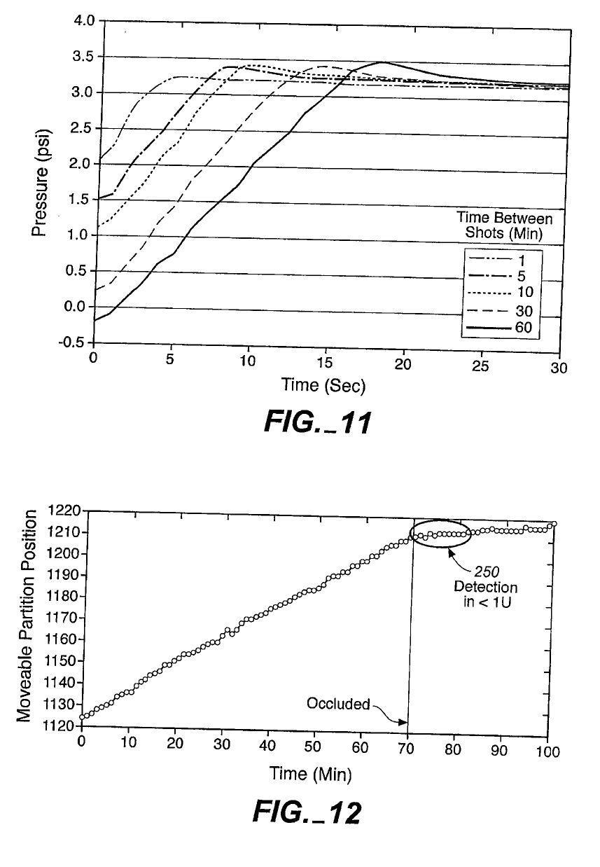

FIG. 10 is a flow diagram illustrating a method of detecting occlusions in an electrokinetic infusion pump with closed loop control 100 according to an embodiment of the present invention. With reference to FIG. 10, and FIGS. 1 through 8, closed loop controller 105 starts with a normal status 246. In the next step, closed loop controller 105 determines position 250 of moveable partition 120. After determining the position 250 of moveable partition 120, closed loop controller 105 waits before dose 252. During this time, the pressure in electrokinetic infusion pump 103 decreases. After waiting before dose 252, a fixed volume is dosed 254. This is accomplished by activating the electrokinetic engine 102. As a result of dosing a fixed volume 254 (electrokinetic engine on time), the pressure in electrokinetic infusion pump 103 increases as a function of time, as illustrated in FIG. 11. Multiple graphs are illustrated in FIG. 11, showing the effect of time between shots (electrokinetic engine off time) on pressure in electrokinetic infusion pump 103. Waiting 1 minute between shots results in a rapid build up of pressure. Waiting 5 minutes between shots results in a longer time to build pressure. The rate at which pressure builds is the same in each graph, but the starting pressure decreases as a function of time between shots, and therefore results in longer times to build pressure. Each graph eventually reaches the same approximate pressure, in this case about 3.2 psi. This is the pressure needed to displace moveable partition 120. Returning to FIG. 10, after dosing a fixed amount 254, and waiting after dose 256 (during which time the pressure in electrokinetic infusion pump 103 increases), the change in position 258 of moveable partition 120 is determined. The position of moveable partition 120 can be determined using a variety of techniques, as mentioned previously. After determining the change in position 258 of moveable partition 120, closed loop controller 105 determines if moveable partition 120 has moved as expected 260, or if it has not moved as expected 264. If moveable partition 120 has moved as expected 260, then no occlusion 262 has occurred, and the closed loop controller 105 returns to normal status 246. If the moveable partition 120 has not moved as expected 264, then an occlusion 266 has occurred, and the closed loop controller 105 enters an alarm status 248. FIG. 12 is a graph illustrating the position of moveable partition 120 as a function of time when an occlusion occurs in an electrokinetic infusion pump with closed loop control 100, according to the embodiment described in the previous example (i.e., running with a series of on/off times using feedback control). As can be seen in FIG. 12, after about 70 minutes the rate at which moveable partition 120 moves as a function of time suddenly decreases in region 250. This indicates that an occlusion has occurred, blocking the movement of moveable partition 120.

What is claimed is:

1. A method of controlling fluid delivery from an infusion pump having a non-mechanically-driven moveable partition, comprising:
delivering at least one fluid shot amount from the infusion pump;
determining at least one measured amount for the at least one fluid shot amount;
calculating an average measured amount using the at least one measured amount;
calculating a correction factor using the average measured amount and an expected amount; and
adjusting subsequent fluid delivery from the infusion pump based at least in part on the correction factor.

2. The method of claim 1, wherein delivering the at least one fluid shot amount includes delivering a plurality of fluid shot amounts, and adjusting subsequent fluid delivery includes delivering a subsequent fluid shot amount based at least in part on the correction factor.

3. The method of claim 2, wherein determining at least one measured amount includes determining a measured amount for each of the plurality of fluid shot amounts.

4. The method of claim 1, wherein calculating the average measured amount includes using at least one weighting factor to weight at least one measured amount.

5. The method of claim 4, wherein calculating the average measured amount includes using at least one weighting factor to more heavily weight at least one later measured amount relative to at least one earlier measured amount.

6. The method of claim 1, wherein calculating the average measured amount includes using a previous average measured amount to calculate the average measured amount.

7. The method of claim 6, wherein calculating the average measured amount includes using the following relationship
$${average}_{n} = \frac{( ɛ \times {amt}_{last , meas} ) + {average}_{n - 1}}{ɛ + 1}$$
wherein:
n is a number equal to a selected number of measured amounts;
averageₙ is the average measured amount calculated using the last n measured amounts;
ε is a designated weighting factor;
amt_{last,meas} is the last measured amount; and
averageₙ₋₁ is the previous average measured amount calculated using all n measured amounts except for the last measured amount.

8. The method of claim 1, wherein calculating the correction factor includes relating the correction factor to a difference between the average measured amount and the expected amount.

9. The method of claim 8, wherein calculating the correction factor further includes relating the correction factor to a product of a proportionality factor and the difference between the average measured amount and the expected amount.

10. The method of claim 2, wherein delivering the subsequent fluid shot amount includes adjusting operation of the infusion pump using the correction factor to deliver a subsequent shot amount.

11. The method of claim 10, wherein adjusting operation includes altering a shot duration corresponding with the subsequent fluid shot amount.

12. The method of claim 1, wherein the infusion pump is an electrokinetic infusion pump.

13. The method of claim 12, wherein adjusting subsequent fluid delivery includes using the correction factor to control at least one of voltage and current applied between electrodes of the electrokinetic infusion pump.

14. The method of claim 1, wherein the step of determining at least one measured amount includes determining a position of the movable partition in the infusion pump.

15. A system for controlling fluid flow from an infusion pump having a non-mechanically-driven moveable partition, comprising:
a position detector coupled to the movable partition for driving fluid from the infusion pump, the position detector configured to emit a signal that identifies the position of the movable partition; and
a controller coupled to the position detector and the movable partition, the controller configured to control delivery of fluid from the infusion pump based at least in part upon an expected amount and an average measured amount calculated from at least one previously measured amount.

16. The system of claim 15, wherein the controller is configured to control delivery of a fluid shot amount from the infusion pump, and the average measured amount is calculated from a plurality of previously measured amounts.

17. The system of claim 16, wherein the controller is configured to obtain each of the plurality of previously measured amounts based at least in part upon a corresponding signal received from the position detector.

18. The system of claim 15, wherein the position detector comprises at least one of a magnetic sensor and an optical sensor.

19. The system of claim 18, wherein the position detector comprises at least one magnetic sensor coupled to a housing of the infusion pump, and at least one magnet coupled to the movable partition.

20. The system of claim 15, wherein the controller is configured to calculate the average measured amount by applying at least one weighting factor to at least one previously measured amount.

21. The system of claim 20, wherein the controller is configured to calculate the average measured amount based at least in part on a previously calculated average measured amount.

22. The system of claim 21, wherein the controller is configured to calculate the average measured amount by applying the following relationship:
$${average}_{n} = \frac{( ɛ \times {amt}_{last , meas} ) + {average}_{n - 1}}{ɛ + 1}$$
wherein:
n is a number equal to the plurality of previously measured amounts;
averageₙ is the average measured amount using n previously measured amounts;
ε is a designated weighting factor;
amt_{last,meas} is a last measured amount; and
averageₙ₋₁ is the average measured amount using all n previously measured amounts except for the last measured amount.

23. The system of claim 15, wherein the controller is configured to control fluid delivery based in part on at least a designated fraction of a difference between the average measured amount and the expected amount.

24. The system of claim 15, wherein the controller is coupled to a power source for driving the infusion pump, the controller configured to control fluid delivery by adjusting power delivered by the power source.

25. The system of claim 15, wherein the infusion pump is an electrokinetic infusion pump.

26. The system of claim 25, wherein the controller is configured to control at least one of voltage applied between electrodes of the electrokinetic infusion pump and current flow between electrodes of the electrokinetic infusion pump.

27. The system of claim 15, wherein the controller is configured to control the delivery of a plurality of fluid shot amounts, and a shot duration associated with each fluid shot amount.
